(19) United States
(12) Patent Application Publication
(10) Pub. No.: US 2010/0092674 A1
(43) Pub. Date: Apr. 15, 2010

(54) INK JET RECORDING METHOD, INK CARTRIDGE, AND RECORDING DEVICE

(75) Inventors: Hiroshi MUKAI, Shiojiri-shi (JP); Katsuko AOKI, Nagano-ken (JP)

Correspondence Address: LADAS & PARRY, 26 West 61st. Street, New York, NY, 10023, US

(73) Assignee: SEIKO EPSON CORPORATION

(21) Appl. No.: 12/578,033

(22) Filed: Oct. 13, 2009

(30) Foreign Application Priority Data
Oct. 15, 2008 (JP) 2008-266028

(51) Int. Cl. B05D 5/00; C09D 11/10; B41J 2/01

(52) U.S. Cl. 427/256; 524/457; 347/100

(57) ABSTRACT

An ink jet recording method for forming an image by adhering water-based ink to a metallic foil medium, in which the method includes forming an image while heating the medium to 40° C. to 50° C., the amount of ink droplets to be adhered to the medium is 4 to 25 ng per dot, and the water-based ink contains a pigment, 3 to 11 mass of a water-soluble resin solvent, 0.5 to 1.1 mass of a water-soluble resin, 2.1 to 4.5 mass of a resin emulsion, and a surfactant.

### BACKGROUND

1. Technical Field

The present invention relates to an ink jet recording method, an ink cartridge, and a recording device.

2. Related Art

The ink jet recording method is a printing method including discharging and flying small ink droplets from a minute nozzle head, and adhering the same to a recording medium, such as paper, for printing. This method allows high speed printing of a high resolution and high quality image by a relatively inexpensive apparatus.

In recent years, a technique of carrying out recording on a non-water absorbing medium using the ink jet recording method has been proposed. For example, an ink composition for ink jet suitably used in direct printing on a hydrophobic base (JP-A-2000-44858) or a polymer colloid containing ink jet ink (JP-A-2005-220352) that can be printed on a nonporous base has been proposed.

However, when printed on metallic foil using such ink with a printing density in such a manner that a base does not expose, there arises a problem in that cracks occur in a recording film after several minutes to several hours have passed after printing.

### SUMMARY

An advantage of some aspects of the invention is to provide an ink jet recording method, an ink cartridge, and a recording device that allow high image quality recording using water-based ink on a metallic foil medium.

The invention provides: (1) an ink jet recording method for forming an image by adhering water-based ink to a metallic foil medium, in which the method includes forming an image while heating the medium to 40° C. to 50° C., the amount of ink droplets to be adhered to the medium is 4 to 25 ng per dot, and the water-based ink contains a pigment, 3 to 11 mass % of a water-soluble resin solvent, 0.5 to 1.1 mass % of a water-soluble resin, 2.1 to 4.5 mass % of a resin emulsion, and a surfactant;

(2) An ink cartridge, containing a water-based ink containing 3 to 11 mass % of a water-soluble resin solvent, 0.5 to 1.1 mass % of a water-soluble resin, 2.1 to 4.5 mass % of a resin emulsion, and a surfactant; and

(3) A recording device having the ink cartridge according to (2) above.

According to the ink jet recording method of the invention, when recorded on a recording medium having, for example, a metallic foil printing surface, the development of cracks in a recording film is suppressed, and thus a high quality image can be obtained.

A high image quality is obtained and moreover scratch resistance and printing stability are excellent.

### DESCRIPTION OF EXEMPLARY EMBODIMENTS

Next, embodiments of the invention will be described. The following embodiments are only exemplifications for describing the invention and are not intended to limit the invention only to the embodiments. The invention can be implemented in various modes insofar as they do not depart from the scope.

An ink jet recording method of the invention is a recording method for forming an image by adhering water-based ink to a metallic foil medium, in which the method includes forming an image while heating the medium to 40° C. to 50° C., the amount of ink droplets to be adhered to the medium is 4 to 25 ng per dot, and the water-based ink contains a pigment, 3 to 11 mass % of a water-soluble resin solvent, 0.5 to 1.1 mass % of a water-soluble resin, 2.1 to 4.5 mass % of a resin emulsion, and a surfactant.

According to the ink jet recording method of the invention, when recorded on a metallic foil recording medium, the development of cracks in a recording film is suppressed, a high quality image can be obtained, and moreover scratch resistance and printing stability can be maintained.

Examples of the recording medium include recording media each having a layer containing metallic foil, such as aluminum foil, copper foil, or stainless steel foil, on the surface.

Heating is carried out so that the temperature of the medium during recording reaches 40° C. to 50° C.

By adjusting the heating temperature to 40° C. to 50° C., the development of cracks in a recording film can be suppressed while preventing clogging and maintaining printing stability.

The amount of ink droplets to be adhered to the medium is 4 to 25 ng per dot.

Thus, by adjusting the ink dot size to a preferable range, the development of cracks in a recording film can be effectively suppressed and a high quality image can be obtained.

In the ink jet recording method, the development of cracks in a recording film can be prevented by adjusting the ink amount per unit area of printed matter to be lower than 5.42 mg/cm².

For example, when printing is carried out with 180×360 dpi by 18 times, the amount of ink droplets of 1.812 mg/cm² on the printing surface is equivalent to the ink dot size of 10 ng, the amount of ink droplets of 3.62 mg/cm² is equivalent to the ink dot size of 20 ng, and the amount of ink droplets of 5.42 mg/cm² is equivalent to the dot size of 30 ng.

In the ink jet recording method, it is preferable to dry the medium by heating after recording. Preferable conditions for drying by heating are a temperature of 40 to 80° C. and a period of time of 1 minute or more.

The water-based ink contains a pigment, 3 to 11 mass % of a water-soluble resin solvent, 0.5 to 1.1 mass % of a water-soluble resin, 2.1 to 4.5 mass % of a resin emulsion, and a surfactant.

The ink cartridge of the invention contains the water-based ink. By the use of such an ink cartridge for the ink jet recording method, the development of cracks in a recording film can be suppressed and a high quality image can be obtained, when recorded on a metallic foil medium.

As the pigment, any of known inorganic pigments, organic pigments, and carbon blacks can be used. Among the above, carbon blacks and organic pigments are preferable from the viewpoint that they exhibit favorable coloring and they are hard to precipitate during dispersion due to a low specific gravity.

Specific examples of preferable carbon blacks include furnace black, lamp black, acetylene black, and channel black (C.I. pigment black 7). Examples of commercially available carbon blacks include No. 2300, 900, MCF88, No. 20B, No. 33, No. 40, No. 45, No. 52, MA7, MA8, MA100, and No. 2200B (trade names, all manufactured by Mitsubishi Chemical, Inc.), Color black FW1, FW2, FW2V, FW18, FW200, S150, S160, S170, Pritex 35, U, V, 140U, Special black 6, 5, 4A, 4, and 250 (trade names, all manufactured by Degussa AG), Conductex SC, Raven 1255, 5750, 5250, 5000, 3500, 1255, and 700 (trade names, all manufactured by Colombia Carbon), Regal 400R, 330R, and 660R, Mogul L, Monarch 700, 800, 880, 900, 1000, 1100, 1300, and 1400, and Elftex 12 (trade names, all manufactured by Cabot Corp.). The carbon blacks above are simply mentioned as one example of carbon blacks suitable for the invention, and the invention is not limited by the description. These carbon blacks may be used singly or as a mixture of two or more thereof. The content of these carbon blacks is 0.5 mass % to 20 mass % and preferably 1 mass % to 10 mass % based on the total amount of a black ink composition.

Examples of preferable organic pigments include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perynone pigments, quinophthalone pigments, anthraquinone pigments, thioindigo pigments, benzimidazolone pigments, isoindolinone pigments, azomethine pigments, and azo pigments.

Specific examples of organic pigments to be used in a water-based ink composition include the following pigments.

Examples of pigments for use in a cyan ink composition include C.I. pigment blue 1, 2, 3, 15:3, 15:4, 15:34, 16, 22, and 60; and C.I. Vat blue 4 and 60, and preferably, examples include a single pigment or a mixture of two or more pigments selected from the group consisting of C.I. pigment blue 15:3, 15:4, and 60. The content of the pigments is about 0.5 mass % to 20 mass % and preferably about 1 mass % to 10 mass % based on the total amount of the cyan ink composition.

Examples of pigments for use in a magenta ink composition include C.I. pigment red 5, 7, 12, 48 (Ca), 48 (Mn), 57 (Ca), 57:1, 112, 122, 123, 168, 184, and 202 and C.I. pigment violet 19 and preferably, examples include a single pigment or a mixture of two or more pigments selected from the group consisting of C.I. pigment red 122, 202, and 209 and C.I. pigment violet 19. The content of the pigments is about 0.5 mass % to 20 mass % and preferably about 1 mass % to 10 mass % based on the total amount of the magenta ink composition.

Examples of pigments for use in a yellow ink composition include C.I. pigment yellow 1, 2, 3, 12, 13, 14C, 16, 17, 73, 74, 75, 83, 93, 95, 97, 98, 119, 110, 114, 128, 129, 138, 150, 151, 154, 155, 180, and 185 and preferably, examples include a single pigment or a mixture of two or more pigments selected from the group consisting of C.I. pigment yellow 74, 109, 110, 128, 138, 180, and 185. The content of the pigments is about 0.5 mass % to 20 mass % and preferably about 1 mass % to 10 mass % based on the total amount of the yellow ink composition.

As a pigment for use in an orange ink composition, C.I. pigment orange 36 or 43 or a mixture thereof is mentioned. The content of the pigments is about 0.5 mass % to 20 mass % and preferably about 1 mass % to 10 mass % based on the total amount of the orange ink composition.

As a pigment for use in a green ink composition, C.I. pigment green 7 or 36 or a mixture thereof is mentioned. The content of the pigments is about 0.5 mass % to 20 mass % and preferably about 1 mass % to 10 mass % based on the total amount of the green ink composition.

In order for the above-mentioned pigments to be more stably dispersed and held in the water-based ink composition, various kinds of methods can be applied. Examples of the methods include a dispersing method using a resin dispersing agent, a dispersing method using a surfactant, and a method for rendering the pigment dispersible and/or soluble by chemically and/or physically introducing a hydrophilic functional group into the surface of pigment particles. Any of the methods above can be used for the water-based ink composition for use in the recording method according to this Embodiment, and, as required, the methods can be used in combination. The ink composition of this Embodiment contains a water-soluble resin described later and the water-soluble resin also functions as the resin dispersing agent, and thus the description of the method using the resin dispersing agent is omitted.

Examples of surfactants that can be used for dispersing pigments include anionic surfactants, such as alkane sulfonate salts, α-olefin sulfonate salts, alkylbenzene sulfonate salts, alkylnaphthalene sulfonate salts, acylmethyl taurate salts, dialkyl sulfosuccinate salts, alkyl sulfate ester salts, olefin sulfates, polyoxyethylene alkyl ether sulfate ester salts, alkyl phosphate ester salts, polyoxyethylene alkyl ether phosphate ester salts, or monoglycerite phosphate ester salts, amphoteric surfactants, such as alkyl pyridium salts, alkylamino acid salts, or alkyldimethyl betaines, and nonionic surfactants, such as polyoxyethylene alkyl ethers, polyoxyethylene alkylphenyl ethers, polyoxyethylene alkyl esters, polyoxyethylene alkylamides, glycerol alkyl esters, or sorbitan alkyl esters.

The addition amount of the resin dispersing agent or the surfactant mentioned above relative to the pigment is preferably 1 mass % to 100 mass % and more preferably 5 mass % to 50 mass % per mass % of the pigment. Based on the fact that the addition amount thereof is in the range, dispersion stability of the pigment in water can be secured.

Examples of the method for rendering the pigment dispersible and/or soluble by chemically and/or physically introducing a hydrophilic functional group into the surface of pigment particles include a method for introducing as a hydrophilic functional group, into the pigment, —OM, —COOM, —CO—, —SO₃M, —SO₂NH₂, —RSO₂M, —PO₃HM, —PO₃M₂, —SO₂NHCOR, —NH₃, —NR₃ (in Formulae, M represents a hydrogen atom, an alkali metal, ammonium, or organic ammonium, R represents an alkyl group having 1 to 12 carbon atoms, a phenyl group that may have a substituent, or a naphthyl group that may have a substituent.). These functional groups are physically and/or chemically introduced into the surface of pigment particles by grafting thereon directly and/or through another group. Examples of polyvalent groups include alkylene groups having 1 to 12 carbon atoms, a phenyl group that may have a substituent, and a naphthyl group that may have a substituent.

As the surface treatment method, a method for surface treating the surface of pigment particles with a treatment agent containing sulfur so that —SO₃M and/or —RSO₂M (M is a counter ion and represents a hydrogen ion, an alkali metal ion, an ammonium ion, or an organic ammonium ion) are/is chemically bonded to the surface of the pigment particles, i.e., a method for rendering the pigment dispersible and/or soluble in water by dispersing the pigment in a solvent which has no active protons and has no reactivity with sulfonic acid and in which the pigment is insoluble or difficult to dissolve, and then surface treating the same so that SO₃M and/or —RSO₂M are/is chemically bonded to the surface of the particles by amidosulfuric acid or a complex of sulfur trioxide and tertiary amine, is more preferable.

As a surface treating measure for grafting the functional group or a salt thereof on the surface of the pigment particles directly or through a polyvalent group, various known surface treating measures are applicable. Examples include a measure including acting ozone or a sodium hypochlorite solution on a commercially available carbon black oxide, and further oxidizing the carbon black for further hydrophilizing the surface (e.g., JP-A-7-258578, JP-A-8-3498, JP-A-10-120958, JP-A-10-195331, and JP-A-10-237349), a measure for treating carbon black with a 3-amino-N-alkyl-substituted pyridium bromide (e.g., JP-A-10-195360 and JP-A-10-330665), a measure including dispersing an organic pigment in a solvent in which the organic pigment is insoluble or difficult to dissolve, and introducing a sulfone group into the surface of pigment particles by a sulfonating agent (e.g., JP-A-8-283596, JP-A-10-110110, and JP-A-10-110114), and a measure for dispersing an organic pigment in a basic solvent forming a complex with sulfur trioxide, and surface treating the surface of the organic pigment by adding sulfur trioxide for introducing a sulfone group or a sulfone amino group (e.g., JP-A-10-110114). The measures for producing the surface treated pigments for use in the invention are not limited to these measures.

A single type or a plurality of types of functional groups may be grafted on one carbon black particle. The type and the grafting degree of the functional group(s) to be grafted may be determined as appropriate considering dispersion stability in ink, color density, and drying properties on the front surface of an ink jet head.

The method for dispersing a pigment in water can be carried out by adding, for a resin dispersing agent, a pigment, water, and resin, adding, for a surfactant, a pigment, water, and a surfactant, and, for a surface treated pigment, adding the pigment and water, and, as required, adding a water soluble organic solvent, a neutralizer, etc., to each thereof in a disperser used in former cases, such as a ball mill, a sand mill, an attritor, a roll mill, an agitator mill, a Henschel mixer, a colloid mill, an ultrasonic homogenizer, a jet mill, or an Ong Mill. In this case, it is preferable to disperse the pigment until the particle diameter of the pigment becomes 20 nm to 500 nm and more preferably 50 nm to 200 nm in terms of average particle diameter from the viewpoint of securing dispersion stability of the pigment in water.

Examples of the water-soluble resin solvent include N-methyl-2-pyrrolidone, N-ethyl-2-pyrrolidone, N-vinyl-2-pyrrolidone, N-butyl-2-pyrrolidone, and 5-methyl-2-pyrrolidone. The water-soluble resin solvent acts as a resolvent for the resin emulsion and the water-soluble resin to be blended in the water-based ink. The water-soluble resin solvent has actions of accelerating film formation by the resin emulsion and the water-soluble resin to be blended in a water-based ink composition when the ink dries, and accelerating solidification and fixation of the ink on a non-ink absorbing metallic foil medium. When the content of the water-soluble resin solvent is lower than 3 mass %, the scratch resistance of printed matter cannot be maintained. In contrast, when the content of the water-soluble resin solvent exceeds 11 mass %, cracks develop in a recording film in some cases.

When the water-soluble resin solvent is contained in a proportion of 3 to 11 mass % relative to the total amount of the water-based ink, the development of cracks in a recording film can be prevented and the scratch resistance of printed matter can be maintained.

Examples of the water-soluble resin include polyvinyl alcohols, polyvinyl pyrrolidones, polyacrylic acids, acrylic acid-acrylicnitrile copolymers, vinyl acetate-acrylic acid ester copolymers, acrylic acid-acrylic acid ester copolymers, styrene-acrylic acid copolymers, styrene-methacrylic acid copolymers, styrene-methacrylic acid-acrylic acid ester copolymers, styrene-α-methylstyrene-acrylic acid copolymers, styrene-α-methylstyrene-acrylic acid-acrylic acid ester copolymers, styrene-maleic acid copolymers, styrene-maleic anhydride copolymers, vinyl naphthalene-acrylic acid copolymers, vinyl naphthalene-maleic acid copolymers, vinyl acetate-maleic acid ester copolymers, vinyl acetate-crotonic acid copolymers, and vinyl acetate-acrylic acid copolymers, and salts thereof. Among the above, copolymers of monomers having hydrophobic functional groups and monomers having hydrophilic functional groups and polymers composed of monomers having both hydrophobic functional groups and hydrophilic functional groups are preferable. As the form of copolymers, any form of a random copolymer, a block copolymer, an alternating copolymer, and a graft copolymer can be used.

Examples of the salts include salts with basic compounds, such as ammonia, ethylamine, diethylamine, triethylamine, propylamine, isopropylamine, dipropylamine, butylamine, isobutylamine, diethanolamine, triethanolamine, tri-iso-propanolamine, aminomethyl propanol, or morpholine. The addition amount of these basic compounds is not limited insofar as the addition amount thereof is equal to or more than the neutralization equivalent of the water-soluble resin.

The molecular weight of the water-soluble resin is preferably in the range of 1,000 to 100000 and more preferably 3,000 to 10000 in terms of weight average molecular weight. Based on the fact that the molecular weight is in the range above, stable dispersion of a colorant in water is achieved and it is easy to carry out viscosity control or the like when applied to a water-based ink composition. The acid value is preferably in the range of 50 to 300 and more preferably in the range of 70 to 150. Based on the fact that the acid value is in the range above, dispersibility of color particles in water can be stably secured and the water resistance of printed matter obtained by printing with a water-based ink composition using the same is favorable.

Commercially available water-soluble resins can also be used as the water-soluble resin described above. In detail, JONCRYL 67 (weight average molecular weight: 12,500, acid value: 213), JONCRYL 678 (weight average molecular weight: 8,500, acid value: 215), JONCRYL 586 (weight average molecular weight: 4,600, acid value: 108), JONCRYL 611 (weight average molecular weight: 8,100, acid value: 53), JONCRYL 680 (weight average molecular weight: 4,900, acid value: 215), JONCRYL 682 (weight average molecular weight: 1,700, acid value: 238), JONCRYL 683 (weight average molecular weight: 8,000, acid value: 160), JONCRYL 690 (weight average molecular weight: 16,500, acid value: 240) (trade names, manufactured by BASF Japan, Inc.), etc., are mentioned.

One of the functions of the water-soluble resin is to improve the dispersibility of the pigments mentioned above. Another one of the functions of the water soluble resin composition is to suppress the development of cracks in a recording film while improving the adhesiveness between the recording medium and the ink composition, and/or the solids in the ink composition when the water-based ink composition adheres to the recording medium.

Based on the fact that the water-soluble resin is contained in a proportion of 0.5 to 1.1 mass % based on the total amount of the water-based ink, the development of cracks in a recording film can be prevented under specific printing conditions.

The resin emulsion has an action of preventing the development of cracks by solidifying ink due to drying of ink, and firmly fixing ink solidified matter on a medium. Examples of components constituting the resin emulsion include polyacrylic acids or copolymers thereof, polymethacrylic acid esters or copolymers thereof, polyacrylonitriles or copolymers thereof, polycyanoacrylates, polyacrylamides, polyacrylic acids, polymethacrylic acids, polyethylenes, polypropylenes, polybutenes, polyisobutylenes, polystyrenes or copolymers thereof, petroleum resins, chroman.indene resins, terpene resins, polyvinyl acetates or copolymers thereof, polyvinyl alcohols, polyvinyl acetals, polyvinyl ethers, polyvinyl chlorides or copolymers thereof, polyvinylidene chlorides, fluororesins, fluororubbers, polyvinyl carbazoles, polyvinyl pyrrolidones or copolymers thereof, polyvinyl pyridines, polyvinyl imidazoles, polybutadienes or copolymers thereof, polychloroprenes, polyisoprenes, and natural resins. Among the above, particularly components having both a hydrophobic portion and a hydrophilic portion in the molecular structure are more preferable.

As the resin emulsion described above, those obtained by known materials and methods can also be used. For example, those described in JP-B-62-1426, JP-A-3-56573, JP-A-3-79678, JP-A-3-160068, and JP-A-4-18462, etc., may also be used. Moreover, commercially available resin emulsions can also be used. Examples include Microgel E-1002 and Microgel E-5002 (trade names, manufactured by Nippon Paint Co., Ltd.), Boncoat 4001 and Boncoat 5454 (trade names, manufactured by Dainippon Ink & Chemicals, Inc.), SAE1014 (trade name, manufactured by Nippon Zeon Co., Ltd.), Saibinol SK-200 (trade name, manufactured by SAIDEN CHEMICAL INDUSTRY CO., LTD.), JONCRYL 7100, JONCRYL 390, JONCRYL 711, JONCRYL 511, JONCRYL 7001, JONCRYL 632, JONCRYL 741, JONCRYL 450, JONCRYL 840, JONCRYL 74J, JONCRYL HRC-1645J, JONCRYL 734, JONCRYL 852, JONCRYL 7600, JONCRYL 775, JONCRYL 537J, JONCRYL 1535, JONCRYL PDX-7630A, JONCRYL 352J, JONCRYL 352D, JONCRYL PDX-7145, JONCRYL 538J, JONCRYL 7640, JONCRYL 7641, JONCRYL 631, JONCRYL 790, JONCRYL 780, and JONCRYL 7610 (trade names, manufactured by BASF Japan, Inc.).

The resin emulsion is obtained by methods described below, and any method of the methods is acceptable. As required, the resin emulsion may be obtained by combining a plurality of methods. Examples of the methods include a method including mixing a polymerization catalyst (polymerization initiator) and a dispersing agent in monomers of components constituting a desired resin emulsion, and polymerizing the same (i.e., emulsion polymerization), a method including dissolving a thermoplastic resin having a hydrophilic portion in a water soluble organic solvent, mixing the solution in water, and removing the water soluble organic solvent by distillation or the like, thereby obtaining the resin emulsion, and a method including dissolving a thermoplastic resin in a water-insoluble organic solvent, and mixing the solution in an aqueous solution with a dispersing agent, thereby obtaining the resin emulsion. The methods can be suitably selected according to the type and the properties of the thermoplastic resin to be used. There is no limitation on a dispersing agent that can be used for dispersing the resin emulsion. Examples include anionic surfactants (e.g., a sodium dodecylbenzenesulfonate salt, a laurylphosphate sodium salt, and a polyoxyethylene alkyl ether sulfate ammonium salt), and nonionic surfactants (e.g., polyoxyethylene alkyl ether, polyoxyethylene alkyl ester, polyoxyethylene sorbitan fatty acid ester, and polyoxyethylene alkyl phenyl ether). The surfactants can be used singly or as a mixture of two or more thereof.

Based on the fact that the resin emulsion is contained in a proportion of 2.1 to 4.5 mass % based on the total amount of the ink, clogging caused by continuous printing by heater heating (40 to 50° C.) can be prevented while preventing the development of cracks. When the proportion of the resin emulsion exceeds 4.5 mass relative to the total amount of the ink, clogging occur in some cases in continuous printing by heater heating (40 to 50° C.).

As the surfactant, polysiloxane compounds that are silicon surfactants are preferably used, and, for example, polyether-modified organosiloxane and the like are mentioned. In more detail, examples include BYK-306, BYK-307, BYK-333, BYK-341, BYK-345, BYK-346, and BYK-348 (trade names, manufactured by BYK chemie Japan, Inc.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemicals Co., Ltd.). Moreover, as the surfactant, acetyleneglycol surfactants can be blended. Examples of acetyleneglycol surfactants include Surfinol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, and GA (trade names, all manufactured by Air Products and Chemicals. Inc.), Olfine B, Y, P, A, STG, SPC, E1004, E1010, PD-001, PD-002W, PD-003, PD-004, EXP. 4001, EXP. 4036, EXE. 4051, AF-103, AF-104, AK-02, SK-14, and AE-3 (trade names, all manufactured by Nisshin Chemical Industry Co., Ltd.), ACETYLENOL E00, E00P, E40, and E100 (trade names, manufactured by Kawaken Fine Chemicals Co., Ltd.).

Based on the fact that the water-based ink contains a surfactant, a phenomenon can be prevented in which the water-based ink adhering to a medium flows before drying to develop spotted unevenness when recorded on a medium having a metallic foil printing surface.

The recording device of the invention is equipped with the ink cartridge described above.

### Examples

Each ink composition was prepared with the compositions shown in Table 1-1 and Table 1-2. The numerical values in Table 1-1 and Table 1-2 all represent mass %.

In the preparation of the ink compositions, a pigment was added to a water-based ink composition after the pigment was dispersed with a water-soluble resin in advance.

The pigment dispersion liquid was prepared as follows. First, to 84.4 parts by mass of ion exchanged water in which 0.6 part by mass of a 30% aqueous ammonia solution (neutralizer) was dissolved, 3 parts by mass of an acrylic acid-acrylic acid ester copolymer (weight average molecular weight: 25,000, acid value: 180) was added as a water-soluble resin for dissolution. To the solution, 12 parts by mass of a pigment was added, and dispersed using zirconia beads for 10 hours in a ball mill. Thereafter, centrifugal filtration by a centrifugal separator was carried out to remove impurities, such as coarse particles or wastes, and the pigment concentration was adjusted to be 12 mass %.

Next, the pigment dispersion liquid and the materials shown in Table 1-1 and Table 1-2 were placed in a container, the mixture was stirred and mixed with a magnetic stirrer for 2 hours, and the resultant was filtered through a membrane filter having a pore size of 5 μm to remove impurities, such as wastes or coarse particles, thereby preparing the respective ink compositions. Water was added so that the compositions shown in Table 1-1 and Table 1-2 were finally obtained.

TABLE 1-1

| | Composition 1 | Composition 2 | Composition 3 | Composition 4 | Composition 5 | Composition 6 |
|---|---|---|---|---|---|---|
| Colorant | 4.0 | 4.0 | 4.0 | 4.0 | 4.0 | 4.0 |
| Water- | 1.1 | 1.1 | 0.5 | 0.5 | 1.1 | 0.5 |
| soluble resin | | | | | | |
| Resin | 2.1 | 4.5 | 2.1 | 4.5 | 2.1 | 2.1 |
| emulsion | | | | | | |
| NMP | 11.0 | 11.0 | 11.0 | 11.0 | 3.0 | 3.0 |
| 1,2- | 7.0 | 7.0 | 7.0 | 7.0 | 7.0 | 7.0 |
| hexanediol | | | | | | |
| BYK348 | 0.5 | 0.5 | 0.5 | 0.5 | 0.5 | 0.5 |
| Water | Balance | Balance | Balance | Balance | Balance | Balance |

TABLE 1-2

| | Composition 7 | Composition 8 | Composition 9 | Composition 10 | Composition 11 | Composition 12 |
|---|---|---|---|---|---|---|
| Colorant | 4.0 | 4.0 | 4.0 | 4.0 | 4.0 | 4.0 |
| Water- | 1.1 | 1.1 | 1.1 | 1.25 | 1.1 | 0.3 |
| soluble resin | | | | | | |
| Resin | 1.5 | 4.5 | 5.0 | 4.5 | 2.1 | 4.5 |
| emulsion | | | | | | |
| NMP | 11.0 | 12.5 | 11.0 | 11.0 | 2.5 | 11.0 |
| 1,2- | 7.0 | 7.0 | 7.0 | 7.0 | 7.0 | 7.0 |
| hexanediol | | | | | | |
| BYK348 | 0.5 | 0.5 | 0.5 | 0.5 | 0.5 | 0.5 |
| Water | Balance | Balance | Balance | Balance | Balance | Balance |

In Table 1-1 and Table 1-2, the colorant is C.I. pigment blue 15:3, the water-soluble resin is an acrylic acid-acrylic ester copolymer, the resin emulsion is a styrene-acrylic acid copolymer, the water-soluble resin solvent is N-methyl-2-pyrrolidone (NMP), and the surfactant is BYK348 (silicon surfactant, manufactured by BYK chemie Japan).

### Printing Test

In a modified printer in which a heater was added to a paper feed portion of Ink Jet Printer PX-G930 (manufactured by Seiko Epson Corporation), the respective ink compositions mentioned above were placed, and printing evaluation was carried out.

As a recording medium, aluminum foil paper (S shine PW8E, manufactured by LINTEC Corp.) was used. As a printing pattern, a solid pattern was used.

### Cracks

After printing, the resultant was heated for 1 minute in a 50° C. thermostat, and then was allowed to stand at room temperature for completely drying. The presence of cracks in a recording medium after completely drying was evaluated based on the following criteria.

[symbol] : No cracks

o: No cracks causing exposure of a base

x: Cracks causing exposure of a base

### Scratch Resistance

The recording medium after completely drying was rubbed 50 times with a unbleached muslin cloth with a load of 500 g, and then analyzed for the presence of defects on the printing surface using a rubbing tester (Japan Society for the Promotion of Science type).

[symbol] : No defects on the printing surface

o: No defects causing exposure of a base

x: Defects causing exposure of a base

### Continuous Printing Stability

The presence of nozzle clogging after continuous printing of 12 paper was evaluated.

[symbol] : No ink adhesion around the nozzle and no nozzle clogging

o: Ink adhesion around the nozzle but no nozzle clogging

x: Nozzle clogging

The evaluation results are shown in Tables 2-1 to 7.

TABLE 2-1
Media temperature 50° C., Ink droplet size 20 ng

| | Ex. 1 | Ex. 2 | Ex. 3 | Ex. 4 | Ex. 5 | Ex. 6 |
|---|---|---|---|---|---|---|
| | Composition 1 | Composition 2 | Composition 3 | Composition 4 | Composition 5 | Composition 6 |
| Cracks | ◯ | ◯ | ◯ | ◯ | ◯ | ◯ |
| Scratch | [symbol] | [symbol] | ◯ | ◯ | [symbol] | ◯ |
| resistance | | | | | | |
| Continuous | [symbol] | ◯ | [symbol] | ◯ | [symbol] | [symbol] |
| printing | | | | | | |
| stability | | | | | | |

TABLE 2-2

| | Comp. Ex. 1 | Comp. Ex. 2 | Comp. Ex. 3 | Comp. Ex. 4 | Comp. Ex. 5 | Comp. Ex. 6 |
|---|---|---|---|---|---|---|
| | Composition 7 | Composition 8 | Composition 9 | Composition 10 | Composition 11 | Composition 12 |
| Cracks | X | X | ◯ | X | ◯ | ◯ |
| Scratch | ◯ | [symbol] | [symbol] | [symbol] | X | X |
| resistance | | | | | | |
| Continuous | [symbol] | ◯ | X | ◯ | [symbol] | ◯ |
| printing | | | | | | |
| stability | | | | | | |

TABLE 3-1
Media temperature 40° C., Ink droplet size 20 ng

| | Ex. 7 | Ex. 8 | Ex. 9 | Ex. 10 | Ex. 11 | Ex. 12 |
|---|---|---|---|---|---|---|
| | Composition 1 | Composition 2 | Composition 3 | Composition 4 | Composition 5 | Composition 6 |
| Cracks | ◯ | ◯ | ◯ | ◯ | ◯ | ◯ |
| Scratch | [symbol] | [symbol] | ◯ | ◯ | [symbol] | ◯ |
| resistance | | | | | | |
| Continuous | [symbol] | ◯ | [symbol] | ◯ | [symbol] | [symbol] |
| printing | | | | | | |
| stability | | | | | | |

TABLE 3-2

| | Comp. Ex. 7 | Comp. Ex. 8 | Comp. Ex. 9 | Comp. Ex. 10 | Comp. Ex. 11 | Comp. Ex. 12 |
|---|---|---|---|---|---|---|
| | Composition 7 | Composition 8 | Composition 9 | Composition 10 | Composition 11 | Composition 12 |
| Cracks | X | X | ◯ | X | ◯ | ◯ |
| Scratch | ◯ | [symbol] | [symbol] | [symbol] | X | X |
| resistance | | | | | | |
| Continuous | [symbol] | ◯ | X | ◯ | [symbol] | ◯ |
| printing | | | | | | |
| stability | | | | | | |

TABLE 4
Media temperature 50° C., Ink droplet size 10 ng

| | Ex. 13 | Ex. 14 | Ex. 15 | Ex. 16 | Ex. 17 | Ex. 18 |
|---|---|---|---|---|---|---|
| | Composition 1 | Composition 2 | Composition 3 | Composition 4 | Composition 5 | Composition 6 |
| Cracks | [symbol] | [symbol] | [symbol] | [symbol] | [symbol] | [symbol] |
| Scratch | [symbol] | [symbol] | ◯ | ◯ | [symbol] | ◯ |
| resistance | | | | | | |
| Continuous | [symbol] | ◯ | [symbol] | ◯ | [symbol] | [symbol] |
| printing | | | | | | |
| stability | | | | | | |

TABLE 5
Media temperature 50° C., Ink droplet size 30 ng

| | Comp. Ex. 13 | Comp. Ex. 14 | Comp. Ex. 15 | Comp. Ex. 16 | Comp. Ex. 17 | Comp. Ex. 18 |
|---|---|---|---|---|---|---|
| | Composition 1 | Composition 2 | Composition 3 | Composition 4 | Composition 5 | Composition 6 |
| Cracks | X | X | X | X | X | X |
| Scratch | [symbol] | [symbol] | ◯ | ◯ | [symbol] | ◯ |
| resistance | | | | | | |
| Continuous | [symbol] | ◯ | [symbol] | ◯ | [symbol] | [symbol] |
| printing | | | | | | |
| stability | | | | | | |

TABLE 6
Media temperature 30° C., Ink droplet size 20 ng

| | Comp. Ex. 19 | Comp. Ex. 20 | Comp. Ex. 21 | Comp. Ex. 22 | Comp. Ex. 23 | Comp. Ex. 24 |
|---|---|---|---|---|---|---|
| | Composition 1 | Composition 2 | Composition 3 | Composition 4 | Composition 5 | Composition 6 |
| Cracks | X | X | X | X | X | X |
| Scratch | [symbol] | [symbol] | ◯ | ◯ | [symbol] | ◯ |
| resistance | | | | | | |
| Continuous | [symbol] | [symbol] | [symbol] | [symbol] | [symbol] | [symbol] |
| printing | | | | | | |
| stability | | | | | | |

TABLE 7
Media temperature 60° C., Ink droplet size 20 ng

| | Comp. Ex. 25 | Comp. Ex. 26 | Comp. Ex. 27 | Comp. Ex. 28 | Comp. Ex. 29 | Comp. Ex. 30 |
|---|---|---|---|---|---|---|
| | Composition 1 | Composition 2 | Composition 3 | Composition 4 | Composition 5 | Composition 6 |
| Cracks | ◯ | ◯ | ◯ | ◯ | ◯ | ◯ |
| Scratch | [symbol] | [symbol] | ◯ | ◯ | [symbol] | ◯ |
| resistance | | | | | | |
| Continuous | X | X | X | X | X | X |
| printing | | | | | | |
| stability | | | | | | |

As shown in Tables 2-1 to 7, in Examples, suppression of the development of cracks in a recording film, scratch resistance, and continuous printing stability were achieved.

What is claimed is:

1. An ink jet recording method for forming an image by adhering water-based ink to a metallic foil medium,
the method comprising forming an image while heating the medium to 40° C. to 50° C.,
the amount of ink droplets to be adhered to the medium being 4 to 25 ng per dot, and
the water-based ink containing a pigment, 3 to 11 mass % of a water-soluble resin solvent, 0.5 to 1.1 mass % of a water-soluble resin, 2.1 to 4.5 mass % of a resin emulsion, and a surfactant.

2. An ink cartridge, comprising a water-based ink containing 3 to 11 mass % of a water-soluble resin solvent, 0.5 to 1.1 mass % of a water-soluble resin, 2.1 to 4.5 mass % of a resin emulsion, and a surfactant.

3. A recording device, comprising the ink cartridge according to claim 2.
